(19) United States
(12) Patent Application Publication
(10) Pub. No.: US 2017/0138211 A1
(43) Pub. Date: May 18, 2017

(54) RING SEGMENT COOLING STRUCTURE AND GAS TURBINE HAVING THE SAME

(71) Applicant: MITSUBISHI HITACHI POWER SYSTEMS, LTD., Kanagawa (JP)

(72) Inventors: Yoshio FUKUI, Kanagawa (JP); Masamitsu KUWABARA, Kanagawa (JP); Satoshi HADA, Kanagawa (JP)

(21) Appl. No.: 15/127,446

(22) PCT Filed: Mar. 20, 2015
(86) PCT No.: PCT/JP2015/058592

§ 371 Date: Sep. 20, 2016

(30) Foreign Application Priority Data
Mar. 27, 2014 (JP) 2014-067106

(51) Int. Cl. F01D 11/08; F01D 25/12

(52) U.S. Cl. CPC F01D 11/08; F01D 25/12; F05D 2240/11

(57) ABSTRACT

A ring segment cooling structure including: a cavity surrounded by main bodies of segment bodies; and cooling passages arranged inside the main body of the segment body in a circumferential direction, and having one ends communicating with the cavity and the other ends open at lateral ends of the segment body on the front side and the rear side in a rotation direction, wherein the cooling passages include first cooling passages formed in a first region of the segment body located on the front side in the rotation direction and through which cooling air is discharged from the rear side toward the front side in the rotation direction, and second cooling passages formed in a second region of the segment body located on the rear side in the rotation direction and through which the cooling air is discharged from the front side toward the rear side in the rotation direction.

### TECHNICAL FIELD

The present invention relates to a gas turbine that is rotated by combustion gas.

### BACKGROUND ART

A gas turbine is hitherto known that includes a rotating shaft, turbine blades extending toward the radially outer side relative to the rotating shaft, ring segments provided on the radially outer side of the turbine blades at a distance therefrom, and turbine vanes adjacent to the ring segments in the axial direction. The turbine vanes and the ring segments are disposed at a distance from each other, with a cavity extending in the circumferential direction and the radial direction formed between the turbine vanes and the ring segments. Sealing air discharged from the turbine vanes is passed through this cavity to prevent a backflow of combustion gas.

The gas turbine includes a ring segment cooling structure in which the ring segment is cooled as cooling air supplied from a blade ring cavity, which is formed on the radially outer side and surrounded by a turbine chamber or the turbine chamber and a blade ring, flows through cooling passages that are formed inside a segment body to circulate the cooling air inside (e.g., Patent Literature 1 and Patent Literature 2). Casing air on the outlet side of the compressor or bleed air extracted from the compressor is commonly used as cooling air. In the ring segment cooling structure described in Patent Literature 1, cooling passages through which cooling air flows in the combustion gas flow direction are formed inside the segment body. These cooling passages have openings, through which cooling air is supplied, formed at the end of the segment body on the upstream side in the combustion gas flow direction. The ring segment cooling structure described in Patent Literature 1 further includes cooling passages, open toward the ends of the segment body in the rotation direction, at both ends of the segment body on the front side and the rear side in the rotation direction.

In the ring segment cooling structure described in Patent Literature 2, cooling passages for cooling air to flow through are formed inside the segment body in the circumferential direction (toward the front side and the rear side in the rotation direction of the rotating shaft). Moreover, in Patent Literature 2, cooling passages through which cooling air flows toward the front side in the rotation direction of the rotating shaft and cooling passages through which cooling air flows toward the rear side, in the opposite direction from the rotation direction of the rotating shaft, are alternately arranged in the combustion gas flow direction.

### CITATION LIST

### Patent Literatures

Patent Literature 1: International Publication No. WO 2011/024242

Patent Literature 2: U.S. Pat. No. 5,375,973

### SUMMARY OF INVENTION

### Technical Problem

As shown in Patent Literature 1 and Patent Literature 2, both ends of the segment body in the rotation direction can be cooled by providing the cooling passages through which cooling air flows toward both ends of the segment body in the rotation direction. In this respect, as a ring segment cooling structure, the ring segment cooling structure of Patent Literature 1 as well as that of Patent Literature 2 have room for improvement. The ring segment cooling structures of Patent Literature 1 and Patent Literature 2 are complicated, and the cooling air use efficiency can be enhanced only to a limited extent.

Therefore, the present invention aims to provide a ring segment cooling structure that allows cooling air to be efficiently supplied and recycled so as to efficiently cool a ring segment, and a gas turbine having this ring segment cooling structure.

### Solution to Problem

To solve the above problem, the present invention provides a ring segment cooling structure for cooling a ring segment of a gas turbine, the ring segment having a plurality of segment bodies disposed in a circumferential direction so as to form an annular shape and being disposed inside a chamber such that an inner circumferential surface of the ring segment is kept at a constant distance from tips of turbine blades, the ring segment cooling structure including: a cavity that is surrounded by a casing of the chamber and main bodies of the segment bodies and supplied with cooling air; and cooling passages for the cooling air to flow through that are arranged inside the main body of the segment body in the circumferential direction, and have one ends communicating with the cavity and the other ends open at lateral ends of the segment body on the front side and the rear side in a rotation direction, wherein the cooling passages include first cooling passages which are formed in a first region of the segment body located on the front side in the rotation direction and through which the cooling air is discharged from the rear side toward the front side in the rotation direction, and second cooling passages which are formed in a second region of the segment body located on the rear side in the rotation direction and through which the cooling air is discharged from the front side toward the rear side in the rotation direction.

According to this configuration, the first cooling passages communicating with the cavity are provided in the first region and the second cooling passages communicating with the cavity are provided in the second region. In this way, the cooling air is recycled and both ends of the segment body in the rotation direction can be efficiently cooled by a simple structure. Thus, it is possible to efficiently supply cooling air and efficiently cool the ring segment with a reduced amount of cooling air.

It is preferable that the cavity includes a first cavity that is arranged on the radially outer side of the segment body, and a second cavity that is arranged on the radially inner side of the first cavity and has one end communicating with the first cavity and the other end communicating with the one ends of the cooling passages.

According to this configuration, the cooling air can be more evenly supplied to the cooling passages.

It is preferable that the ring segment cooling structure further includes an impingement plate that is arranged in the first cavity and has a large number of openings.

According to this configuration, the segment body is further cooled.

It is preferable that the second cavity is arranged between the first region and the second region in the rotation direction.

According to this configuration, the cooling air is discharged from both lateral ends on the front side and the rear side in the rotation direction, so that the cooling of both lateral ends is further enhanced.

It is preferable that an end part of the cooling passage on the downstream side in a cooling air flow direction is inclined toward a combustion gas flow direction.

According to this configuration, the length of the cooling passages can be increased at both ends in the rotation direction, so that both ends in the rotation direction can be cooled more intensively.

It is preferable that, of the cooling passages, those cooling passages arranged on the downstream side in the combustion gas flow direction are arrayed at a smaller array pitch than those cooling passages arranged on the upstream side in the combustion gas flow direction.

According to this configuration, a larger amount of cooling air can be supplied to the downstream side in the combustion gas flow direction that needs to be cooled more intensively.

To solve the above problem, the present invention further provides a gas turbine including: turbine blades mounted on a rotatable turbine shaft; turbine vanes fixed so as to face the turbine blades in an axial direction; a ring segment surrounding the turbine blades in a circumferential direction; a chamber that is arranged on the outer circumferential side of the ring segment and supports the turbine vanes; and any one of the above-described ring segment cooling structures.

According to this configuration, it is possible to efficiently cool the ring segment and reduce the amount of cooling air discharged into a combustion gas flow passage. Thus, the gas turbine efficiency can be enhanced.

### Advantageous Effects of Invention

According to the present invention, the first cooling passages and the second cooling passages communicating with the cavity are provided, which allows cooling air to be recycled and both ends of the segment body in the rotation direction to be efficiently cooled by a simple structure. Thus, it is possible to efficiently supply cooling air and efficiently cool the ring segment with a reduced amount of cooling air.

### BRIEF DESCRIPTION OF DRAWINGS

FIG. 1 is a schematic configurational view of a gas turbine according to Embodiment 1.

FIG. 2 is a partial sectional view around a turbine of the gas turbine according to Embodiment 1.

FIG. 3 is a partial enlarged view of the vicinity of a ring segment of the gas turbine according to Embodiment 1.

FIG. 4 is a perspective view of a segment body of the ring segment according to Embodiment 1.

FIG. 5 is a sectional view of the segment body of the ring segment according to Embodiment 1.

FIG. 6 is a schematic sectional view, taken along the line A-A of FIG. 5, of the ring segment according to Embodiment 1 as seen from the radial direction.

FIG. 7 is a schematic sectional view, taken along the line B-B of FIG. 6, of the ring segment according to Embodiment 1 as seen from a combustion gas flow direction.

FIG. 8 is a schematic sectional view of a segment body according to a modified example of Embodiment 1 as seen from the radial direction.

FIG. 9 is a schematic sectional view of a segment body according to Embodiment 2 as seen from the radial direction.

FIG. 10 is a sectional view, taken along the line C-C of FIG. 9, of the segment body according to Embodiment 2 as seen from the combustion gas flow direction.

FIG. 11 is a schematic sectional view of a segment body according to Embodiment 3 as seen from the radial direction.

FIG. 12 is a schematic sectional view of a segment body according to Embodiment 4 as seen from the radial direction.

FIG. 13 is a schematic sectional view of a segment body according to Embodiment 5 as seen from the radial direction.

FIG. 14 is a schematic sectional view of a segment body according to Embodiment 6 as seen from the radial direction.

FIG. 15 is a schematic sectional view of a segment body according to Embodiment 7 as seen from the radial direction.

### DESCRIPTION OF EMBODIMENTS

In the following, the present invention will be described with reference to the accompanying drawings. However, the present invention is not limited by the following embodiments. The components in the following embodiments include other components that can be easily used as substitute by those skilled in the art or that are substantially the same.

### Embodiment 1

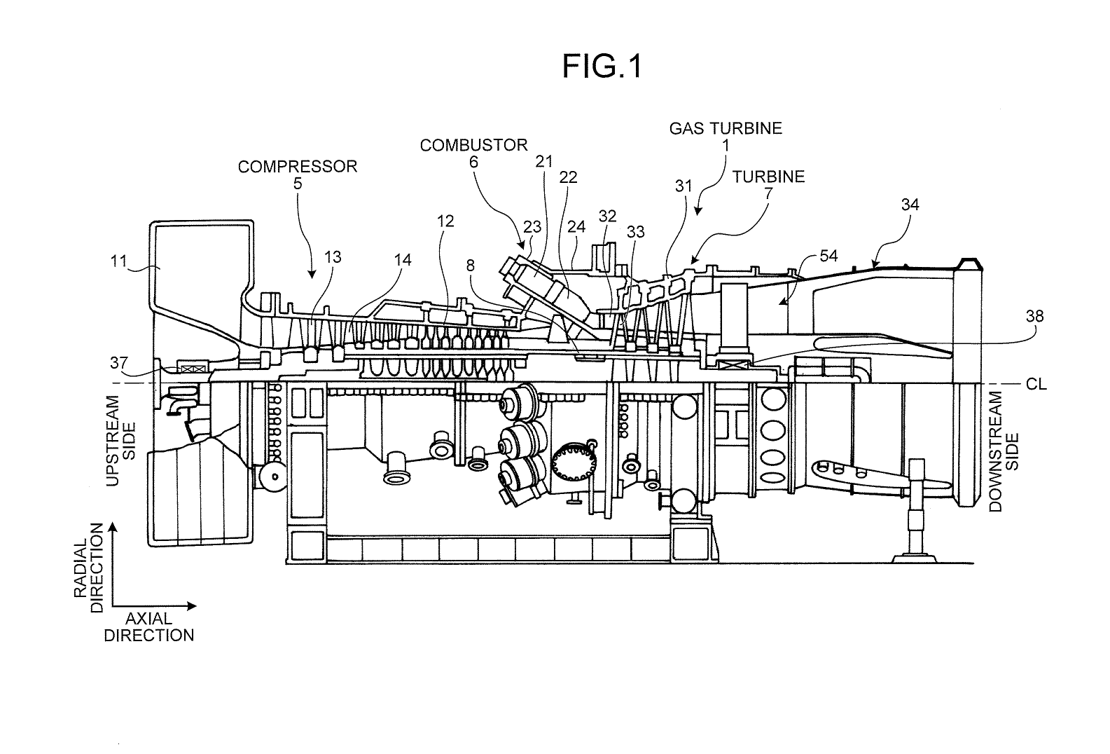

As shown in FIG. 1, a gas turbine 1 of Embodiment 1 is composed of a compressor 5, a combustor 6, and a turbine 7. A turbine shaft 8 is arranged so as to penetrate center parts of the compressor 5, the combustor 6, and the turbine 7. The compressor 5, the combustor 6, and the turbine 7 are installed along a centerline CL of the turbine shaft 8, side by side from the upstream side toward the downstream side in an air or combustion gas flow direction FG.

The compressor 5 compresses air into compressed air. The compressor 5 is provided with multiple stages of compressor vanes 13 and multiple stages of compressor blades 14 inside a compressor casing 12 that has an air inlet 11 through which air is taken in. The compressor vanes 13 of each stage are mounted on the compressor casing 12 and installed side by side in the circumferential direction, while the compressor blades 14 of each stage are mounted on the turbine shaft 8 and installed side by side in the circumferential direction. The multiple stages of the compressor vanes 13 and the multiple stages of the compressor blades 14 are provided alternately along the axial direction.

The combustor 6 supplies fuel to the compressed air having been compressed in the compressor 5 and generates high-temperature, high-pressure combustion gas. The combustor 6 has, as combustion liners, a combustor basket 21 in which the compressed air and the fuel are mixed and combusted, a transition piece 22 that guides the combustion gas from the combustor basket 21 to the turbine 7, and an external cylinder 23 that covers the outer circumference of the combustor basket 21 and guides the compressed air from the compressor 5 to the combustor basket 21. The plurality of combustors 6 are arranged inside a turbine casing 31 in the circumferential direction. The air having been compressed in the compressor 6 is temporarily stored in a chamber 24 surrounded by the turbine casing before being supplied to the combustors 6.

The turbine 7 generates rotary power from the combustion gas produced by the combustors 6. The turbine 7 is provided with multiple stages of turbine vanes 32 and multiple stages of turbine blades 33 inside the turbine casing 31 serving as an outer shell. The plurality of turbine vanes 32 of each stage are mounted on the turbine casing 31 and arranged annularly in the circumferential direction, while the plurality of turbine blades 33 of each stage are fixed to the outer circumference of a disc, which is centered at the centerline CL of the turbine shaft 8, and arranged annularly in the circumferential direction. The multiple stages of the turbine vanes 32 and the multiple stages of the turbine blades 33 are alternately provided along the axial direction.

An exhaust chamber 34 having a diffuser 54 inside that is continuous with the turbine 7 is provided on the downstream side of the turbine casing 31 in the axial direction (see FIG. 1). With its one end on the side of the compressor 5 supported by a bearing 37 and the other end on the side of the exhaust chamber 34 supported by a bearing 38, the turbine shaft 8 is provided so as to be rotatable around the centerline CL. A driving shaft of a generator (not shown) is coupled to the end of the turbine shaft 8 on the side of the exhaust chamber 34.

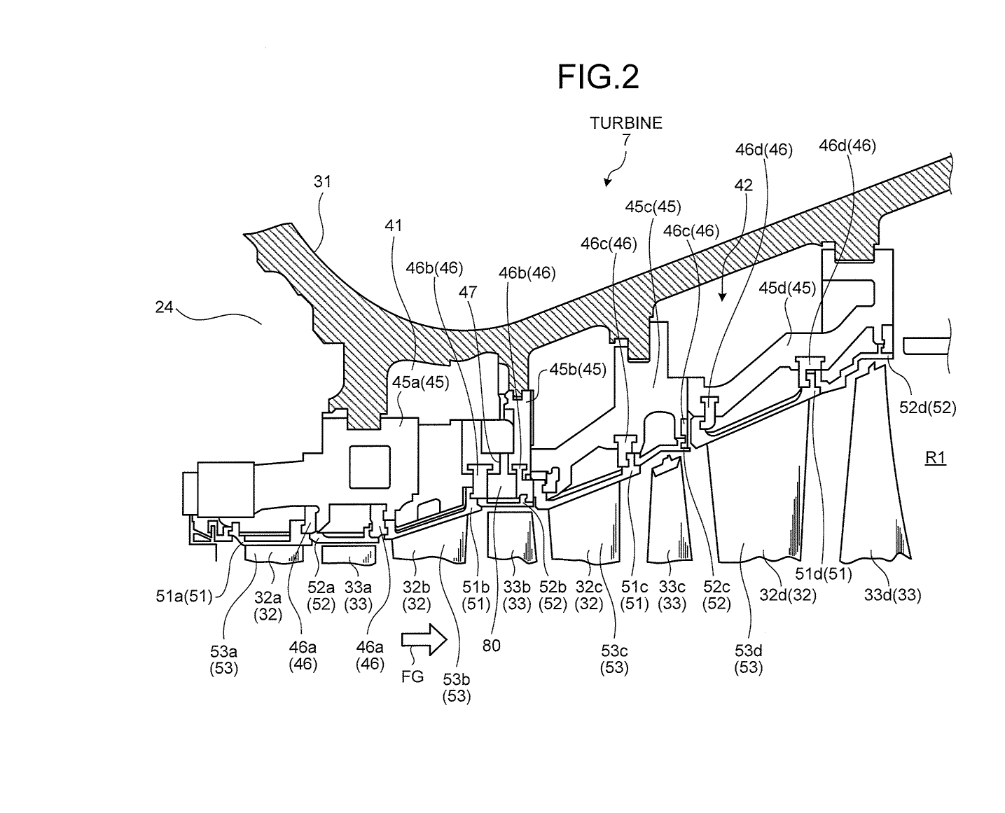

The turbine 7 will be specifically described below with reference to FIG. 2. As shown in FIG. 2, the turbine vane 32 is integrally composed of an outer shroud 51, a airfoil portion 53 extending radially inward from the outer shroud 51, and an inner shroud (not shown) provided on the radially inner side of the airfoil portion 53. The turbine vane 32 is supported by the turbine casing 31 through a isolation ring and a blade ring, and constitutes a part of a fixed side. The multiple stages of the turbine vanes 32 include first turbine vanes 32a, second turbine vanes 32b, third turbine vanes 32c, and fourth turbine vanes 32d in this order from the upstream side in the combustion gas flow direction FG. The first turbine vane 32a is integrally composed of an outer shroud 51a, a airfoil portion 53a, and an inner shroud (not shown). The second turbine vane 32b is integrally composed of an outer shroud 51b, a airfoil portion 53b, and an inner shroud (not shown). The third turbine vane 32c is integrally composed of an outer shroud 51c, a airfoil portion 53c, and an inner shroud (not shown). The fourth turbine vane 32d is integrally composed of an outer shroud 51d, a airfoil portion 53d, and an inner shroud (not shown).

The multiple stages of the turbine blades 33 are arranged so as to respectively face a plurality of ring segments 52 from the radially inner side. The turbine blades 33 of each stage are provided at a distance from the ring segment 52 with a predetermined clearance therebetween, and constitute a part of the movable side. The multiple stages of the turbine blades 33 include first turbine blades 33a, second turbine blades 33b, third turbine blades 33c, and fourth turbine blades 33d in this order from the upstream side in the combustion gas flow direction FG. The first turbine blades 33a are provided on the radially inner side of a first ring segment 52a. Similarly, the second turbine blades 33b, the third turbine blades 33c, and the fourth turbine blades 33d are provided on the radially inner side of a second ring segment 52b, a third ring segment 52c, and a fourth ring segment 52d, respectively.

Thus, the multiple stages of the turbine vanes 32 and the multiple stages of the turbine blades 33 are arranged, from the upstream side in the combustion gas flow direction FG, in the order of the first turbine vanes 32a, the first turbine blades 33a, the second turbine vanes 32b, the second turbine blades 33b, the third turbine vanes 32c, the third turbine blades 33c, the fourth turbine vanes 32d, and the fourth turbine blades 33d, so as to face one another in the axial direction.

As shown in FIG. 2, the turbine casing 31 has a blade ring 45 that is arranged on the radially inner side of the turbine casing 31 and supported by the turbine casing 31. Formed annularly around the turbine shaft 8, the blade ring 45 is divided into a plurality of parts in the circumferential direction and the axial direction and supported by the turbine casing 31. The plurality of blade rings 45 include a first blade ring 45a, a second blade ring 45b, a third blade ring 45c, and a fourth blade ring 45d in this order from the upstream side in the combustion gas flow direction (axial direction) FG. A isolation ring 46 is installed on the radially inner side of the blade ring 45, and the turbine vanes 32 are supported by the blade ring 45 through the isolation ring 46. The plurality of isolation rings 46 include a first isolation ring 46a, a second isolation ring 46b, a third isolation ring 46c, and a fourth isolation ring 46d in this order from the upstream side in the combustion gas flow direction (axial direction) FG.

On the inner side of the blade rings 45, the plurality of turbine vanes 32 and the plurality of ring segments 52 are provided adjacent to each other in the axial direction.

The plurality of turbine vanes 32 and the plurality of ring segments 52 are arranged, from the upstream side in the combustion gas flow direction FG, in the order of the first turbine vanes 32a, the first ring segment 52a, the second turbine vanes 32b, the second ring segment 52b, the third turbine vanes 32c, the third ring segment 52c, the fourth turbine vanes 32d, and the fourth ring segment 52d, so as to face one another in the axial direction.

The first turbine vanes 32a and the first ring segment 52a are mounted on the radially inner side of the first blade ring 45a through the first isolation ring 46a. Similarly, the second turbine vanes 32b and the second ring segment 52b are mounted on the radially inner side of the second blade ring 45b through the second isolation ring 46b; the third turbine vanes 32c and the third ring segment 52c are mounted on the radially inner side of the third blade ring 45c through the third isolation ring 46c; and the fourth turbine vanes 32d and the fourth ring segment 52d are mounted on the radially inner side of the fourth blade ring 45d through the fourth isolation ring 46d.

An annular passage formed between the inner circumferential side of the outer shroud 51 of the plurality of turbine vanes 32 and the plurality of ring segments 52 and the outer circumferential side of the inner shroud of the turbine vanes 32 and a platform of the turbine blades 33 serves as a combustion gas flow passage R1, and combustion gas flows along the combustion gas flow passage R1.

In the gas turbine 1 as describe above, when the turbine shaft 8 is rotated, air is taken in through the air inlet 11 of the compressor 5. The air having been taken in passes through the multiple stages of the compressor vanes 13 and the multiple stages of the compressor blades 14 and is compressed in the process into high-temperature, high-pressure compressed air. Fuel is supplied from the combustors 6 to the compressed air, and high-temperature, high-pressure combustion gas is produced. As the combustion gas passes through the multiple stages of the turbine vanes 32 and the multiple stages of the turbine blades 33 of the turbine 7, the turbine shaft 8 is driven to rotate. Thus, the generator coupled to the turbine shaft 8 generates electrical power as the rotary power is imparted thereto. Then, the combustion gas having driven the turbine shaft 8 to rotate is discharged to the outside of the system through the diffuser 54 inside the exhaust chamber 34.

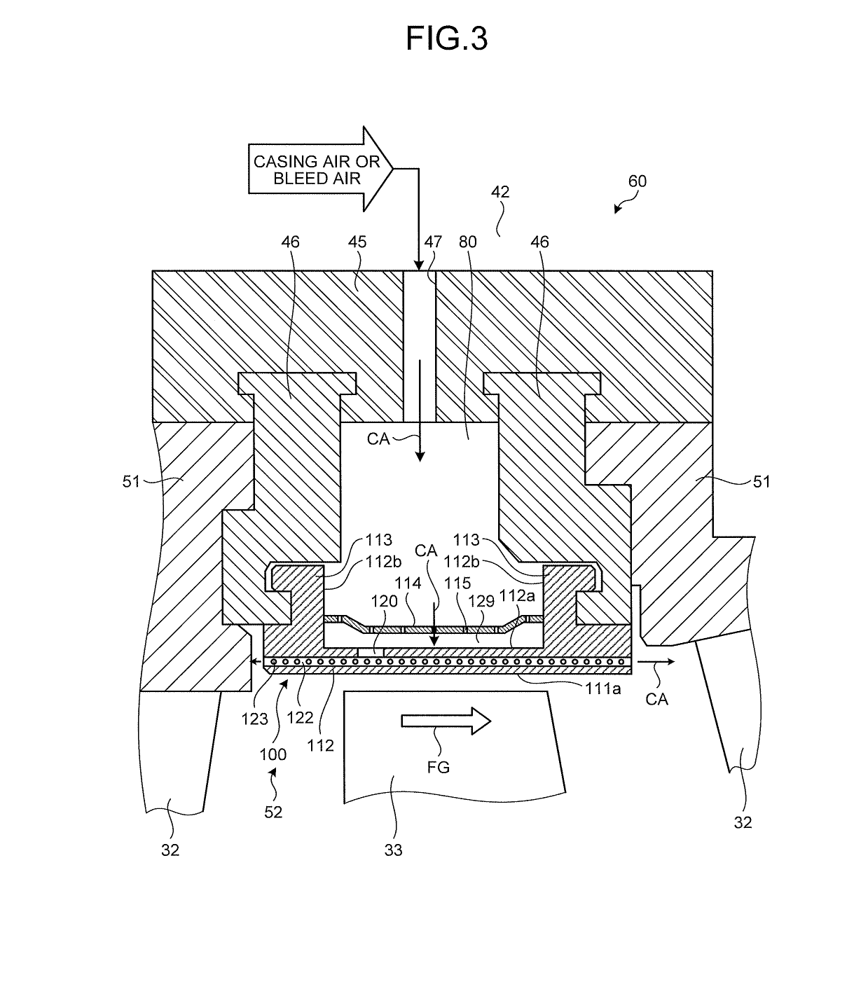

Next, the ring segment and a ring segment cooling structure for cooling the ring segment will be described with reference to FIG. 2 and FIG. 3. FIG. 3 is a partial enlarged view of the ring segment of the gas turbine according to Embodiment 1. Here, only the ring segment cooling structure around the second ring segment 52b is shown in FIG. 2, but the other ring segments have the same structure. As a representative, the second ring segment 52b will be described below as the ring segment 52.

As described in the section of Background Art, cooling air supplied to a ring segment cooling structure 60 is supplied from a blade ring cavity 41 that is surrounded by the turbine chamber and the blade ring 45. The blade ring 45 has a supply opening 47. A first cavity 80 being a space is provided among the isolation ring 46, the blade ring 45, and the ring segment 52. The first cavity 80 is provided annularly in the circumferential direction. The first cavity 80 communicates with the blade ring cavity 42 through the supply opening 47. The ring segment 52 has cooling passages that communicate with the first cavity 80.

Cooling air CA having been supplied to the blade ring cavity 41 of the ring segment cooling structure 60 is supplied through the supply opening 47 into the first cavity 80. Casing air on the outlet side of the compressor or bleed air extracted from the compressor 5 is used as the cooling air CA of this embodiment. The cooling air CA having been supplied into the first cavity 80 is supplied to the ring segment 52, and cools the ring segment 52 by passing through the cooling passages (details will be described later) disposed inside the ring segment 52.

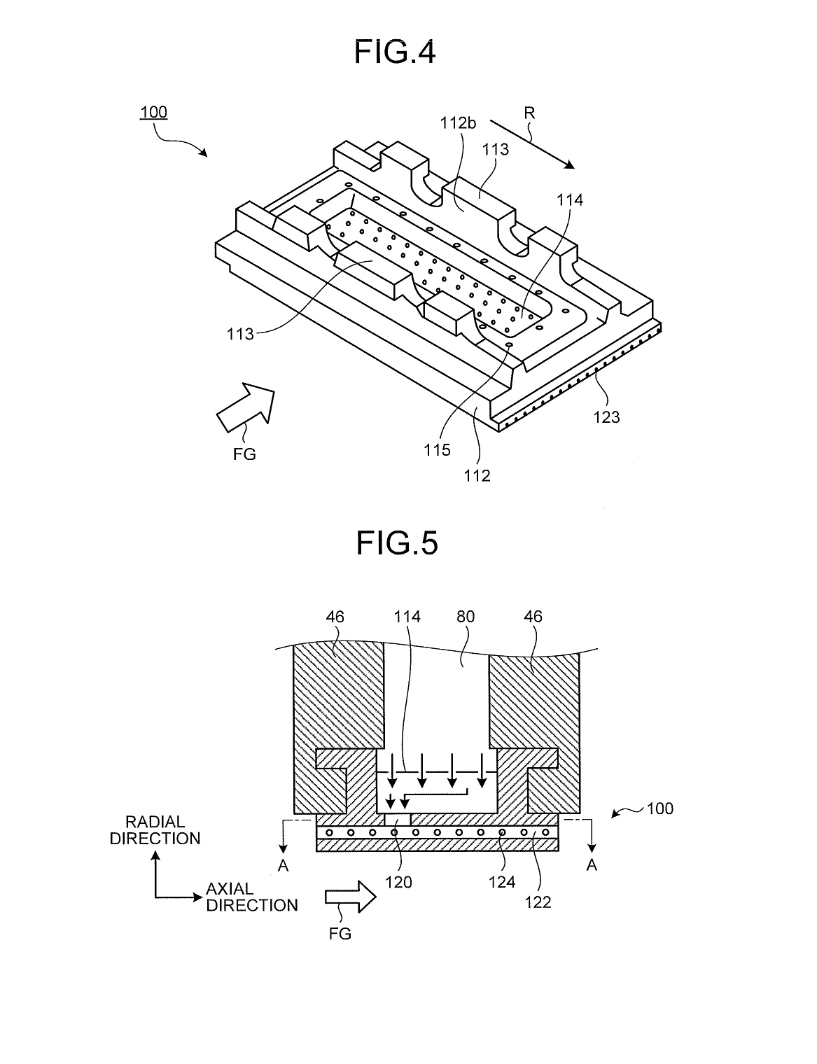

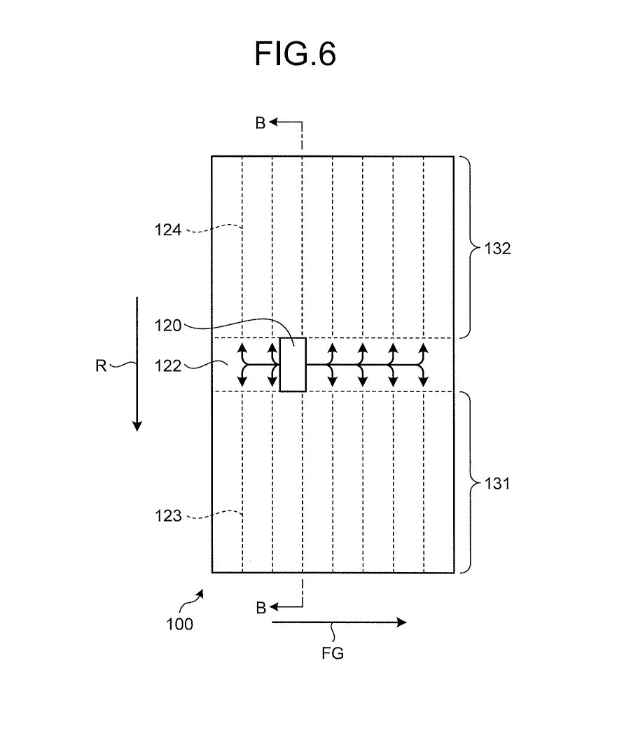

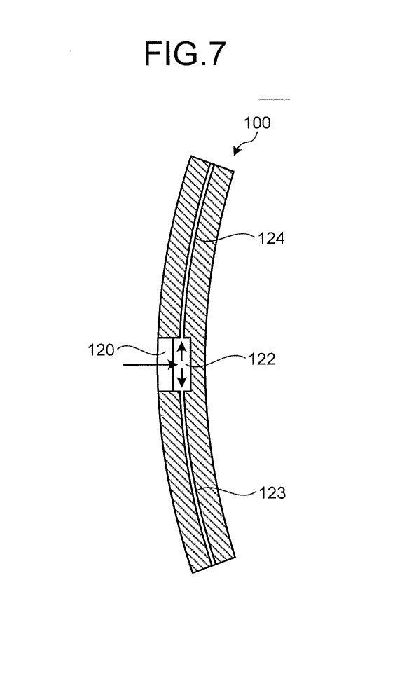

Next, the cooling passages of the ring segment cooling structure 60 will be described in more detail by describing the structure of the ring segment 52 using FIG. 4 to FIG. 7 in addition to FIG. 3. FIG. 4 is a perspective view of a segment body of the ring segment according to Embodiment 1. FIG. 5 is a sectional view of the segment body of the ring segment according to Embodiment 1. FIG. 6 is a schematic sectional view of the ring segment according to Embodiment 1 as seen from the radial direction. FIG. 7 is a sectional view of the ring segment according to Embodiment 1 as seen from the combustion gas flow direction. Here, in this embodiment, the rotation direction of the turbine shaft 8 (the rotation direction of the turbine blades 33) will be denoted by R, and the rotation direction R is the direction orthogonal to the axial direction of the rotating shaft.

The ring segment 52 has a plurality of segment bodies 100 that are disposed in the circumferential direction of the turbine shaft 8 so as to form an annular shape. The segment bodies 100 are arranged such that a constant clearance is secured between inner circumferential surfaces 111a of the segment bodies 100 and the tips of the turbine blades 33. The ring segment 52 is formed from a heat-resisting nickel alloy, for example.

The segment body 100 has a main body 112 and hooks 113. An impingement plate 114 is provided between one hook 113 and the other hook 113 of the segment body 100. The main body 112 is a plate-like member provided with the cooling passages inside that will be described later. The radially inner surface of the main body 112 is a curved surface that is curved along the rotation direction R. The main body 112 has the cooling passages. The shape of the main body 112 will be described later.

The hooks 113 are provided integrally on the radially outer surface of the main body 112, at ends on the upstream side and the downstream side in the combustion gas flow direction FG. The hooks 113 are mounted on the isolation ring 46. Thus, the segment body 100 is supported on the isolation ring 46.

The impingement plate 114 is arranged inside the first cavity 80. Specifically, the impingement plate 114 is arranged further on the radially outer side than the main body 112, at an interval from the radially outer surface 112a of the main body 112. The impingement plate 114 is arranged between the one hook 113 and the other hook 113 of the segment body 100 and fixed to inner walls 112b of the hooks 113 of the segment body 100, and the space on the radially outer side of the main body 112 is closed by the impingement plate 114. Thus, a cooling space 129 is defined as the space surrounded by the main body 112, the impingement plate 114, the hooks 113 provided on the upstream side and the downstream side in the combustion gas flow direction FG, and lateral ends provided on the upstream side and the downstream side in the direction (the rotation direction of the turbine shaft 8) substantially orthogonal to the axial direction of the turbine shaft 8.

A large number of small holes 115 through which the cooling air CA for impingement cooling passes are bored in the impingement plate 114. Accordingly, the cooling air CA having been supplied into the first cavity 80 passes through the small holes 115 while heading for the main body 112, and is discharged into the cooling space 129. Thus, the cooling air CA is jetted out of the small holes 115, thereby impingement-cooling the surface 112a of the main body 112.

Next, the passages for the cooling air CA to flow through that are formed inside the main body 112 will be described using FIG. 3 to FIG. 7. Here, the rear side of the segment body 100 in the rotation direction R refers to the rear side in the arrow direction (the side coming into contact with the rotating blades first), and the front side in the rotation direction R refers to the front side in the arrow direction (the side coming into contact with the rotating blades last).

In the main body 112 of the segment body 100, an opening 120, a second cavity 122, first cooling passages (front-side cooling passages) 123, and second cooling passages (rear-side cooling passages) 124 are formed. The opening 120 is formed on the side of the first cavity 80, i.e., in the radially outer surface of the main body 112, and provides communication between the second cavity 122 and the first cavity 80 (cooling space 129). The opening 120 is formed in the vicinity of the center of the main body 112 in the rotation direction R.

The second cavity 122 is a closed space that is formed inside the main body 112 and long in the combustion gas flow direction FG, and as indicated by the arrow, the upstream side of the second cavity 122 in the flow direction of the cooling air CA communicates with the opening 120, while the downstream side of the second cavity 122 communicates with the first cooling passages 123 and the second cooling passages 124. The second cavity 122 is a space that links the opening 120 to the first cooling passages 123 and the second cooling passages 124, and functions as a manifold that couples the opening 120 to the first cooling passages 123 and the second cooling passages 124.

The first cooling passages 123 are formed in a first region 131 of the main body 112. The first region 131 is a region of the main body 112 located on the front side in the rotation direction R. In the first region 131, the plurality of first cooling passages 123, which are pipelines, extend in the rotation direction R and are formed inside the main body 112 in parallel to one another, with one ends open to the second cavity 122 and the other ends open in the end face of the main body 112 on the front side in the rotation direction R. That is, the first cooling passages 123 provide communication between the second cavity 122 and the combustion gas flow passage R1.

The second cooling passages 124 are formed in a second region 132 of the main body 112. The second region 132 is a region of the main body 112 located on the rear side in the rotation direction R. Here, the end of the second region 132 on the front side in the rotation direction R is located further on the rear side than the end of the first region 131 on the rear side in the rotation direction R. That is, the second region 132 is a region that does not overlap the first region 131. In the second region 132, the plurality of second cooling passages 124, which are pipelines, extend in the rotation direction R and are formed inside the main body 112 in parallel to one another, with one ends open to the second cavity 122 and the other ends open in the end face of the main body 112 on the rear side in the rotation direction R. That is, the second cooling passages 124 provide communication between the second cavity 122 and the combustion gas flow passage R1.

Here, the first cooling passages 123 and the second cooling passages 124 can be formed by various methods. For example, these cooling passages can be formed using the curved hole electrical discharge machining method described in Japanese Patent Laid-Open No. 2013-136140 by which it is possible to move an electrode inside a hole being formed while bending the hole at the machining position. Using this method, one can produce the segment body 100 by machining a plate-like member as required by cutting, electrical discharge machining, etc.

The segment body 100 has the paths for the cooling air CA to flow through as have been described above. In the ring segment cooling structure 60, the cooling air CA having been supplied into the cooling space 129 and impingement-cooled the surface 112a of the segment body 100 passes through the opening 120 and is supplied into the second cavity 122. Having been supplied into the second cavity 122, the cooling air CA flows into the first cooling passages 123 and the second cooling passages 124 while moving inside the second cavity 122 toward the upstream side or the downstream side in the combustion gas flow direction FG. Having flowed into the first cooling passages 123, the cooling air CA flows from the rear side toward the front side in the rotation direction R before being discharged from the end of the segment body 100 on the front side in the rotation direction R into the combustion gas flow passage R1. Having flowed into the second cooling passages 124, the cooling air CA flows from the front side toward the rear side in the rotation direction R before being discharged from the end of the segment body 100 on the rear side in the rotation direction R into the combustion gas flow passage R1.

In the ring segment cooling structure 60 of this embodiment thus configured, it is possible to favorably cool the segment body 100 by supplying the cooling air CA into the first cavity 80 and passing the cooling air CA through the cooling passages formed inside the main body 112 of the segment body 100.

Specifically, the segment body 100 is provided with the plurality of first cooling passages 123 extending in the rotation direction R in the first region 131 and the plurality of second cooling passages 124 extending in the rotation direction R in the second region 132. Thus, it is possible to circulate the cooling air CA inside the segment body 100 and favorably cool the segment body 100 by supplying the cooling air CA into the first cooling passages 123 and the second cooling passages 124. Moreover, since the first cooling passages 123 and the second cooling passages 124 extend in the rotation direction R, discharging the cooling air CA from the ends in the rotation direction R can convectively cool the ends of the segment body 100 in the rotation direction R with the cooling air CA. As a result, the segment body 100 and the ends of the segment body 100 in the rotation direction R can be efficiently cooled. Moreover, in the ring segment cooling structure 60, after the cooling air CA has cooled the entire segment body 100, the same cooling air CA can cool the ends of the segment body 100 by passing through the first cooling passages 123 and the second cooling passages 124. Thus, it is possible to efficiently cool the segment body 100 by recycling the cooling air CA.

Furthermore, the cooling air CA having been supplied into the first cavity 80 is supplied to the first cooling passages 123 and the second cooling passages 124, so that the same cooling air CA cools parts of the main body 112 after cooling parts of the first cavity 80. In this way, the cooling air CA can be efficiently used. Since the cooling air CA can be thus efficiently used, the amount of air used for cooling can be reduced.

With the opening 120 and the second cavity 122 provided in the segment body 100, it is possible to adjust the amount of cooling air flowing into the second cavity 122 by varying the open area of the opening 120. Accordingly, the cooling air CA can be supplied to the cooling passages in a balanced manner. While the impingement plate 114 is provided in the above embodiment to efficiently cool the radially outer surface of the segment body 100, the impingement plate 114 may be omitted.

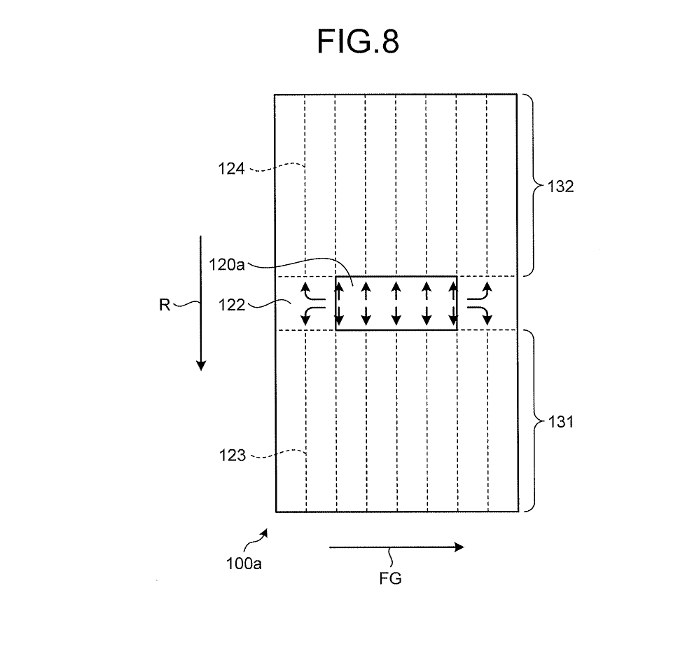

FIG. 8 is a schematic configurational view of the segment body of Embodiment 1 as seen from the radial direction, and shows a modified example in which the open area of the opening 120 provided in the segment body 100 is varied. In a segment body 100a of this modified example, a second cavity 120a is formed in a groove shape in the radially outer circumferential surface of the main body 112, and, without the shield plate provided, the side facing the first cavity 80 is open toward the radially outer side. That is, compared with the structure of the opening 120 shown in FIG. 6, in this modified example, the width of the opening in the rotation direction R is the same but the length of the opening 120 in the combustion gas flow direction FG is increased to substantially the same size as the first cavity 80. Such a structure does not require the second cavity to be formed as a closed space and therefore allows easy machining compared with the structure of Embodiment 1.

### Embodiment 2

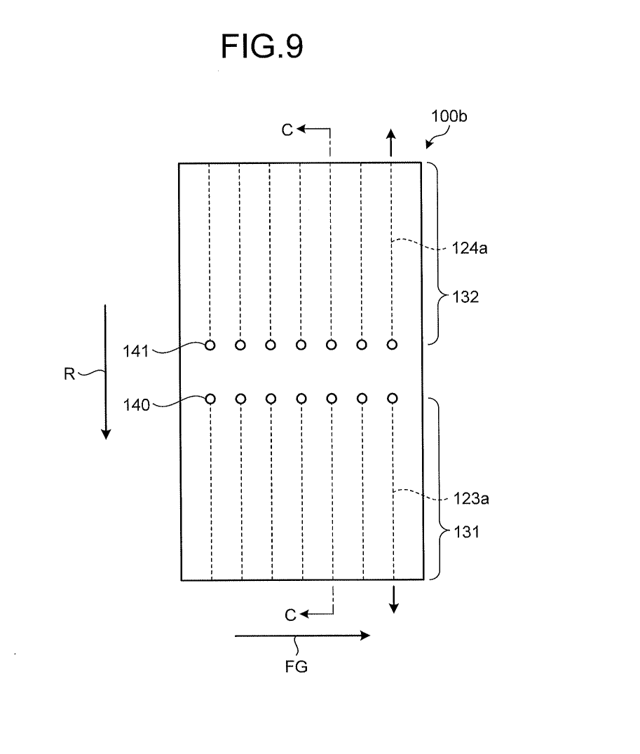

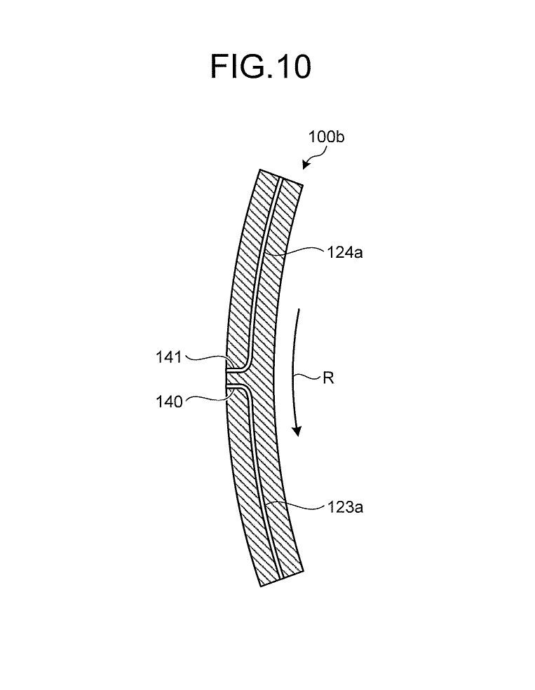

Next, a gas turbine and a ring segment cooling structure according to Embodiment 2 will be described using FIG. 9 and FIG. 10. FIG. 9 is a schematic sectional view of a segment body according to Embodiment 2 as seen from the radial direction. FIG. 10 is a schematic sectional view, taken along the line A-A of FIG. 9, of the segment body according to Embodiment 2 as seen from the combustion gas flow direction. The gas turbine and the ring segment cooling structure according to Embodiment 2 are the same as those of Embodiment 1 except for the structure of the segment body. In the following, differences in the structure of the segment body will be mainly described, while the parts of the same structure will be denoted by the same reference signs and the description thereof will be omitted.

In the main body 112 of a segment body 100b, first cooling passages 123a and second cooling passages 124a are formed. The first cooling passages 123a have one ends connected to openings 140 that are formed in the radially outer surface 112a of the main body 112, i.e., the surface facing the first cavity 80, and the other ends open in the end face on the front side in the rotation direction R. As shown in FIG. 10, the first cooling passages 123a are bent pipes of which the route on the rear side in the rotation direction R is inclined toward the radially outer surface of the main body 112 while extending toward the rear side. The second cooling passages 124a have one ends connected to openings 141 that are formed in the radially outer surface 112a of the main body 112, i.e., the surface facing the first cavity 80, and the other ends open in the end face on the rear side in the rotation direction R. As shown in FIG. 10, the second cooling passages 124a are bent pipes of which the route on the front side in the rotation direction R is inclined toward the radially outer surface of the main body 112 while extending toward the front side. The first cooling passages 123a are formed in the first region 131 and the second cooling passages 124a are formed in the second region 132. The first cooling passages 123a and the second cooling passages 124a that are partially bent can be formed by curved hole electrical discharge machining described above.

Thus, even when the segment body 100b is not provided with the second cavity and the first cooling passages 123a and the second cooling passages 124a directly communicate with the first cavity 80, it is possible to favorably cool the radially inner surface of the segment body 100b as well as favorably cool both ends in the rotation direction through the first cooling passages 123a and the second cooling passages 124a.

### Embodiment 3

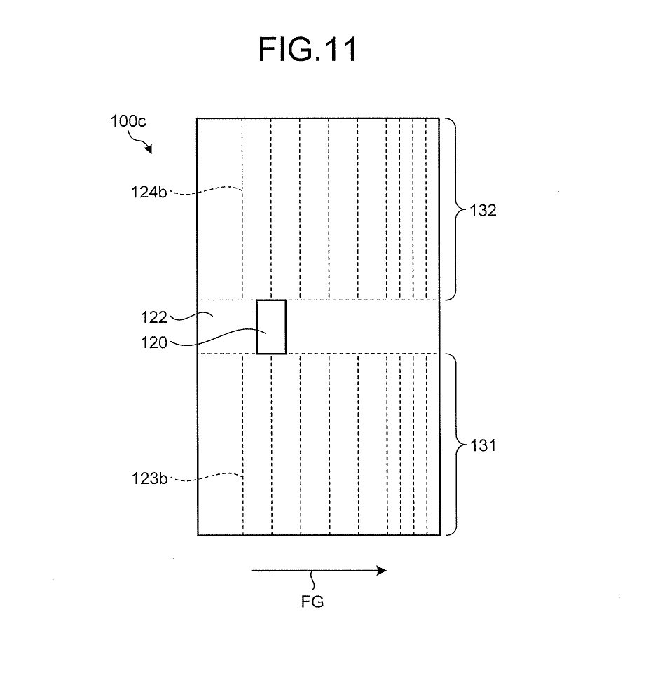

Next, a gas turbine and a ring segment cooling structure according to Embodiment 3 will be described using FIG. 11. FIG. 11 is a schematic sectional view of a segment body according to Embodiment 3 as seen from the radial direction. The gas turbine and the ring segment cooling structure according to Embodiment 3 are the same as those of Embodiment 1 except for the structure of the segment body. In the following, differences in the structure of the segment body will be mainly described, while the parts of the same structure will be denoted by the same reference signs and the description thereof will be omitted.

In the main body 112 of a segment body 100c, the opening 120, the second cavity 122, first cooling passages 123b, and second cooling passages 124b are formed.

The first cooling passages 123b are formed in the first region 131 of the main body 112. In the first region 131, the plurality of first cooling passages 123b, which are pipelines, extend in the rotation direction R and are formed inside the main body 112 in parallel to one another, with one ends open to the second cavity 122 and the other ends open in the end face of the main body 112 on the front side in the rotation direction R. The interval between adjacent ones of the first cooling passages 123b is narrower on the downstream side than on the upstream side in the combustion gas flow direction FG. That is, in the segment body 100c, the first cooling passages 123b are arranged more densely on the downstream side than on the upstream side in the combustion gas flow direction FG.

The second cooling passages 124b are formed in the second region 132 of the main body 112. In the second region 132, the plurality of second cooling passages 124b, which are pipelines, extend in the rotation direction R and are formed inside the main body 112 in parallel to one another, with one ends open to the second cavity 122 and the other ends open in the end face of the main body 112 on the rear side in the rotation direction R. The interval between adjacent ones of the second cooling passages 124b is narrower on the downstream side than on the upstream side in the combustion gas flow direction FG. That is, in the segment body 100c, the second cooling passages 124b are arranged more densely on the downstream side than on the upstream side in the combustion gas flow direction FG.

It is possible to more reliably cool the downstream side of the segment body 100c in the combustion gas flow direction FG by arranging the first cooling passages 123b and the second cooling passages 124b in the segment body 100c such that the number of the cooling passages is larger on the downstream side than on the upstream side in the combustion gas flow direction FG. Thus, a larger amount of cooling air CA can be circulated in the downstream-side part in the combustion gas flow direction FG that needs to be cooled more intensively, so that the segment body 100c can be cooled more efficiently.

### Embodiment 4

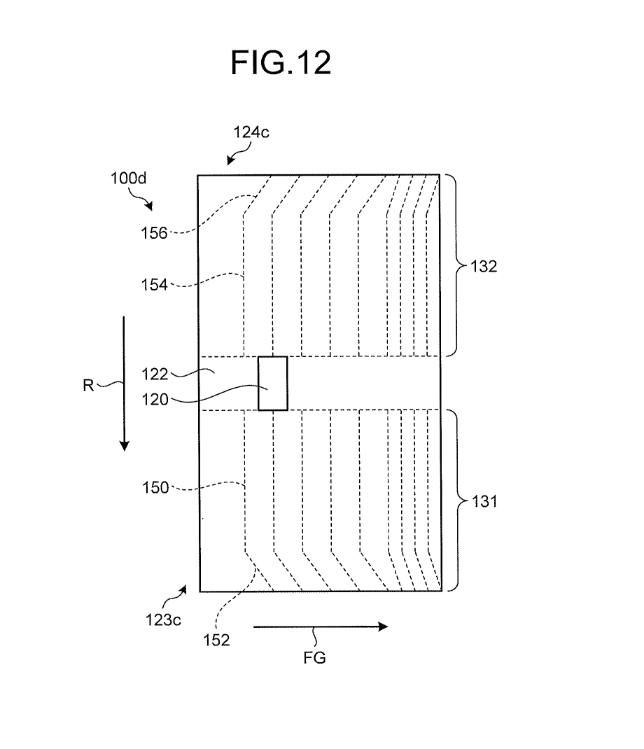

Next, a gas turbine and a ring segment cooling structure according to Embodiment 4 will be described using FIG. 12. FIG. 12 is a schematic sectional view of a segment body according to Embodiment 4 as seen from the radial direction. The gas turbine and the ring segment cooling structure according to Embodiment 4 are the same as those of Embodiment 1 except for the structure of the segment body. In the following, differences in the structure of the segment body will be mainly described, while the parts of the same structure will be denoted by the same reference signs and the description thereof will be omitted.

In the main body 112 of a segment body 100d, the opening 120, the second cavity 122, first cooling passages 123c, and second cooling passages 124c are formed.

The first cooling passages 123c are formed in the first region 131 of the main body 112. In the first region 131, the plurality of first cooling passages 123c are formed side by side in the combustion gas flow direction FG. The first cooling passages 123c have one ends open to the second cavity 122 and the other ends open in the end face of the main body 112 on the front side in the rotation direction R. The first cooling passages 123c have parallel parts 150 that extend in the rotation direction R and are formed inside the main body 112 in parallel to one another, and inclined parts 152 that are inclined relative to the rotation direction R. The parallel parts 150 are connected to the second cavity 122. The inclined parts 152 are connected to the parallel parts 150 and open at the end (the end on the front side) in the rotation direction R. That is, the inclined parts 152 are formed on the front side of the main body 112 in the rotation direction R. The inclined parts 152 are inclined toward the downstream side in the combustion gas flow direction FG while extending toward the front side in the rotation direction R. The interval between adjacent ones of the first cooling passages 123c is narrower on the downstream side than on the upstream side in the combustion gas flow direction FG. That is, in the segment body 100d, the first cooling passages 123c are arranged more densely on the downstream side than on the upstream side in the combustion gas flow direction FG.

The second cooling passages 124c are formed in the second region 132 of the main body 112. In the second region 132, the plurality of second cooling passages 124c are formed side by side in the combustion gas flow direction FG. The second cooling passages 124c have one ends open to the second cavity 122 and the other ends open in the end face of the main body 112 on the rear side in the rotation direction R. The second cooling passages 123c have parallel parts 154 that extend in the rotation direction R and are formed inside the main body 112 in parallel to one another, and inclined parts 156 that are inclined relative to the rotation direction R. The parallel parts 154 are connected to the second cavity 122. The inclined parts 156 are connected to the parallel parts 154 and open at the end (the end on the rear side) in the rotation direction R. That is, the inclined parts 156 are formed on the rear side of the main body 112 in the rotation direction R. The inclined parts 156 are inclined toward the downstream side in the combustion gas flow direction FG while extending toward the rear side in the rotation direction R. The interval between adjacent ones of the second cooling passages 124c is narrower on the downstream side than on the upstream side in the combustion gas flow direction FG. That is, in the segment body 100d, the second cooling passages 124c are arranged more densely on the downstream side than on the upstream side in the combustion gas flow direction FG.

It is possible to increase the length of the cooling passages at both ends of the segment body 100d in the rotation direction R and increase the passage surface area by providing the segment body 100d with the inclined parts 152, 156 on the sides of the first cooling passages 123c and the second cooling passages 124c connected respectively to the end faces in the rotation direction R. Thus, both ends of the segment body 100d in the rotation direction R can be favorably cooled.

### Embodiment 5

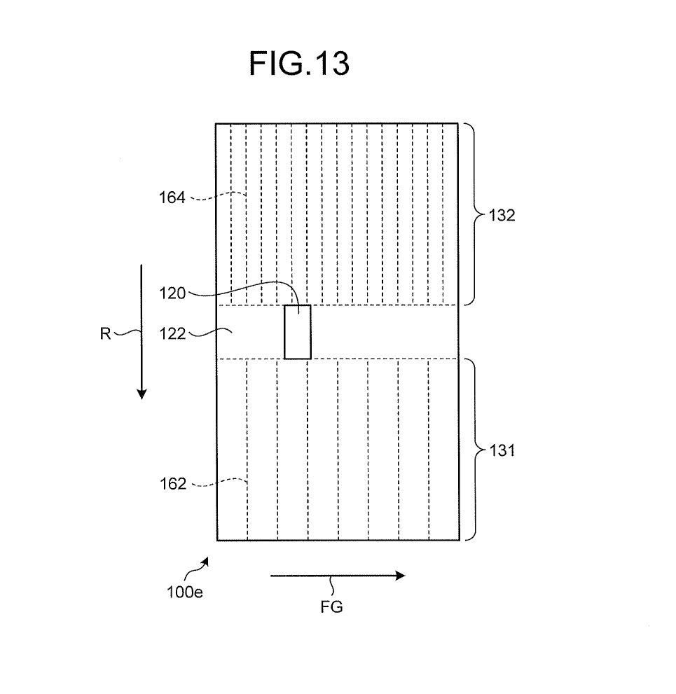

Next, a gas turbine and a ring segment cooling structure according to Embodiment 5 will be described using FIG. 13. FIG. 13 is a schematic sectional view of the segment body according to Embodiment 5 as seen from the radial direction. The gas turbine and the ring segment cooling structure according to Embodiment 5 are the same as those of Embodiment 1 except for the structure of the segment body. In the following, differences in the structure of the segment body will be mainly described, while the parts of the same structure will be denoted by the same reference signs and the description thereof will be omitted.

In the main body 112 of a segment body 100e, the opening 120, the second cavity 122, first cooling passages 162, and second cooling passages 164 are formed.

The first cooling passages 162 are formed in the first region 131 of the main body 112. In the first region 131, the plurality of first cooling passages 162 are formed side by side in the combustion gas flow direction FG. The first cooling passages 162 are pipelines extending in the rotation direction R and formed inside the main body 112 in parallel to one another, with one ends open to the second cavity 122 and the other ends open in the end face of the main body 112 on the front side in the rotation direction R.

The second cooling passages 164 are formed in the second region 132 of the main body 112. In the second region 132, the plurality of second cooling passages 164 are formed side by side in the combustion gas flow direction FG. The second cooling passages 164 are pipelines extending in the rotation direction R and formed inside the main body 112 in parallel to one another, with one ends open to the second cavity 122 and the other ends open in the end face of the main body 112 on the rear side in the rotation direction R.

In the segment body 100e, the number of the second cooling passages 164 is larger than the number of the first cooling passages 162. That is, in the segment body 100e, the second cooling passages 164 are arranged at a higher density of cooling passages than the first cooling passages 162. Accordingly, in the segment body 100e, a larger amount of cooling air CA is supplied to the second region 132 where the second cooling passages 164 are provided. As a result, the second region 132 where the second cooling passages 164 are provided can be cooled more intensively. In this way, the end of the segment body 100e on the rear side in the rotation direction R that is subjected to harsher conditions than the end on the front side in the rotation direction R can be properly cooled. Thus, parts of the segment body can be efficiently cooled by properly supplying the cooling air CA thereto. It is therefore possible to reliably cool the ring segment 52 while reducing the amount of cooling air CA supplied.

### Embodiment 6

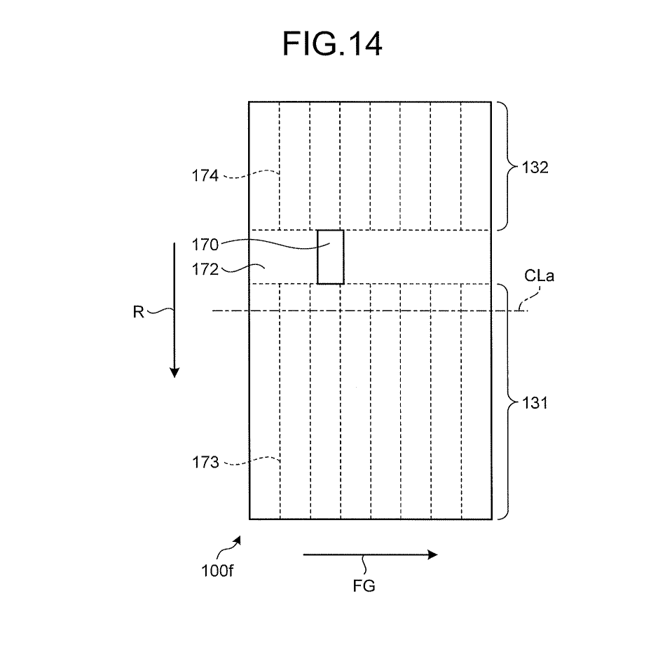

Next, a gas turbine and a ring segment cooling structure according to Embodiment 6 will be described using FIG. 14. FIG. 14 is a schematic sectional view of the segment body according to Embodiment 6 as seen from the radial direction. The gas turbine and the ring segment cooling structure according to Embodiment 6 are the same as those of Embodiment 1 except for the structure of the segment body. In the following, differences in the structure of the segment body will be mainly described, while the parts of the same structure will be denoted by the same reference signs and the description thereof will be omitted.

In the main body 112 of a segment body 100f, an opening 170, a second cavity 172, first cooling passages 173, and second cooling passages 174 are formed. The opening 170 and the second cavity 172 of the segment body 100f are formed further on the rear side in the rotation direction R than a centerline CLa that is parallel to the centerline CL of the turbine shaft 8 and passes through the center of the main body 112 in the rotation direction. Thus, as the opening 170 and the second cavity 172 are formed further on the rear side than the centerline CLa, the first cooling passages 173 are longer than the second cooling passages 174. The relations of connection among the opening 170, the second cavity 172, the first cooling passages 173, and the second cooling passages 174 are the same as those among the opening 120, the second cavity 122, the first cooling passages 123, and the second cooling passages 124 of the segment body 100.

In the segment body 100f, the opening 170 and the second cavity 172 are formed further on the rear side than the centerline CLa so as to make the first cooling passages 173 longer than the second cooling passages 174. In this way, the temperature of the cooling air CA reaching the ends of the second cooling passages 174 on the rear side in the rotation direction R can be made lower than the temperature of the cooling air CA reaching the ends of the first cooling passages 173 on the front side in the rotation direction. Accordingly, the end of the segment body 100f on the rear side in the rotation direction R that is subjected to harsher conditions than the end on the front side in the rotation direction R can be properly cooled. Thus, parts of the segment body can be efficiently cooled by properly supplying the cooling air CA thereto. It is therefore possible to reliably cool the ring segment while reducing the amount of cooling air CA supplied.

### Embodiment 7

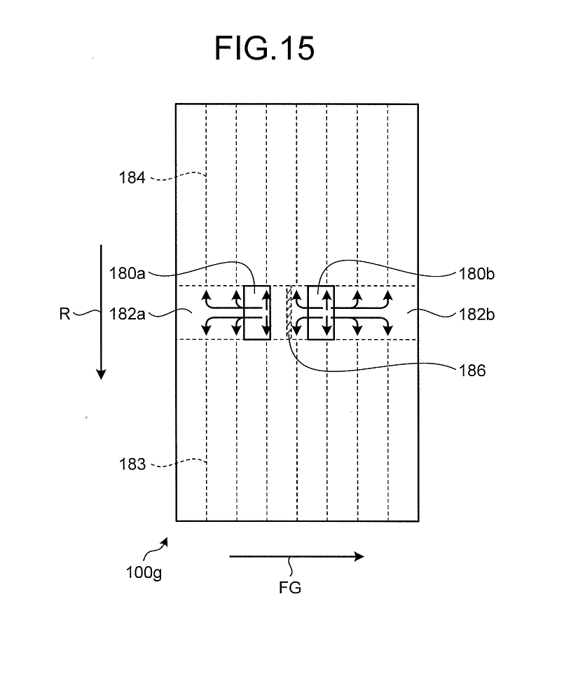

Next, a gas turbine and a ring segment cooling structure according to Embodiment 7 will be described using FIG. 15. FIG. 15 is a schematic sectional view of a segment body according to Embodiment 7 as seen from the radial direction. The gas turbine and the ring segment cooling structure according to Embodiment 7 are the same as those of Embodiment 1 except for the structure of the segment body. In the following, differences in the structure of the segment body will be mainly described, while the parts of the same structure will be denoted by the same reference signs and the description thereof will be omitted.

In the main body 112 of a segment body 100g, openings 180a, 180b, second cavities 182a, 182b, first cooling passages 183, and second cooling passages 184 are formed. The first cooling passages 183 and the second cooling passages 184 are the same as the first cooling passages 123 and the second cooling passages 124.

The opening 180a is formed on the side of the main body 112 facing the first cavity 80, i.e., the radially outer surface, and provides communication between the second cavity 182a and the first cavity 80 (cooling space 129). The opening 180a is formed in the vicinity of the center of the main body 112 in the rotation direction R. The opening 180b is formed on the side of the main body 112 facing the first cavity 80, i.e., the radially outer surface, and provides communication between the second cavity 182b and the first cavity 80 (cooling space 129). The opening 180b is formed in the vicinity of the center of the main body 112 in the rotation direction R. The opening 180b is arranged further on the downstream side in the combustion gas flow direction FG than the opening 180a.

The second cavities 182a, 182b are closed spaces that are formed inside the main body 112 and long in the combustion gas flow direction FG. The second cavities 182a, 182b are partitioned by a partition wall 186 into the second cavity 182a on the upstream side and the second cavity 182b on the downstream side in the combustion gas flow direction FG, and the second cavities 182a, 182b do not communicate with each other. The second cavities 182a, 182b on one side communicate with the opening 180a or 180b and on the other side communicate with the first cooling passages (front-side cooling passages) 183 and the second cooling passages (rear-side cooling passages) 184.

Thus, the ring segment 100g is provided with the second cavities 182a, 182b connected in series in the combustion gas flow direction FG. Accordingly, of the plurality of first cooling passages 183, those first cooling passages 183 formed on the upstream side in the combustion gas flow direction FG communicate with the second cavity 182a, while those first cooling passages 183 formed on the downstream side in the combustion gas flow direction FG communicate with the second cavity 182b. Of the plurality of second cooling passages 184, those second cooling passages 184 formed on the upstream side in the combustion gas flow direction FG communicate with the second cavity 182a, while those second cooling passages 184 formed on the downstream side in the combustion gas flow direction FG communicate with the second cavity 182b.

Thus, the number of the second cavities is not limited to one but a plurality of second cavities may be provided. Moreover, as long as the second cavities communicate with both the first cooling passages 183 and the second cooling passages 184, the positions in the combustion gas flow direction FG and the positions in the rotation direction R are not particularly limited. While the case where the second cavities 182a, 182b are connected in series in the combustion gas flow direction FG has been described, the two second cavities 182a, 182b may be separated from each other. That is, as long as the upstream sides of the cavities 182a, 182b in the cooling air flow direction communicate respectively with the openings 180a, 180b and the downstream sides thereof communicate with the first cooling passages (front-side cooling passages) 183 and the second cooling passages (rear-side cooling passages) 184, the positions in the combustion gas flow direction FG and the positions in the rotation direction R of the second cavities 182a, 182b may be different from each other.

Since the second cavity is divided into a plurality of cavities in the segment body 100g, it is possible to adjust the amount of cooling air flowing into the cavities by varying the open areas of the cavities. Thus, the amount of cooling air CA supplied to the cooling passages at their respective positions can be more finely adjusted.

### REFERENCE SIGNS LIST

2 Gas turbine
5 Compressor
6 Combustor
7 Turbine
8 Turbine shaft
11 Air inlet
12 Compressor casing
13 Compressor vane
14 Compressor blade
21 Combustor basket
22 Transition piece
23 External cylinder
24 Chamber
31 Turbine casing
32 Turbine vane
33 Turbine blade
41 Blade ring cavity
45 Blade ring
46 Isolation ring
51 Outer shroud
52 Ring segment
53 Airfoil portion
60 Ring segment cooling structure
80 First cavity
100 Segment body
112 Main body
113 Hook
114 Impingement plate
115 Small hole
120 Opening
122 Second cavity
123 First cooling passage (front-side cooling passage)
124 Second cooling passage (rear-side cooling passage)
131 First region
132 Second region
R1 Combustion gas flow passage
CA Cooling air

1. A ring segment cooling structure for cooling a ring segment of a gas turbine, the ring segment having a plurality of segment bodies disposed in a circumferential direction, the ring segment cooling structure comprising:
a cavity that is surrounded by main bodies of the segment bodies and supplied with cooling air; and
cooling passages for the cooling air to flow through that are arranged inside the main body of the segment body in the circumferential direction so as to run along an inner circumferential surface of the segment body and form an annular shape, and have one ends communicating with the cavity and the other ends open at lateral ends of the segment body on the front side and the rear side in a rotation direction, wherein
the cooling passages include first cooling passages which are formed in a first region of the segment body located on the front side in the rotation direction and through which the cooling air is discharged from the rear side toward the front side in the rotation direction, and second cooling passages which are formed in a second region of the segment body located on the rear side in the rotation direction and through which the cooling air is discharged from the front side toward the rear side in the rotation direction.

2. The ring segment cooling structure according to claim 1, wherein the cavity includes a first cavity that is arranged on the radially outer side of the segment body, and a second cavity that is arranged on the radially inner side of the first cavity and has one end communicating with the first cavity and the other end communicating with the one ends of the cooling passages.

3. The ring segment cooling structure according to claim 2, further comprising an impingement plate that is arranged in the first cavity and has a large number of openings.

4. The ring segment cooling structure according to claim 2, wherein the second cavity is arranged between the first region and the second region in the rotation direction.

5. The ring segment cooling structure according to claim 1, wherein an end part of the cooling passage on the downstream side in a cooling air flow direction is inclined toward a combustion gas flow direction.

6. The ring segment cooling structure according to claim 1, wherein, of the cooling passages, those cooling passages arranged on the downstream side in the combustion gas flow direction are arrayed at a smaller array pitch than those cooling passages arranged on the upstream side in the combustion gas flow direction.

7. A gas turbine comprising:
turbine blades mounted on a rotatable turbine shaft;
turbine vanes fixed so as to face the turbine blades in an axial direction;
a ring segment surrounding the turbine blades in a circumferential direction;
a chamber that is arranged on the outer circumferential side of the ring segment and supports the turbine vanes; and
the ring segment cooling structure according to claim 1.

8. The ring segment cooling structure according to claim 3, wherein the second cavity is arranged between the first region and the second region in the rotation direction.
